(19) United States
(12) Patent Application Publication
(10) Pub. No.: US 2007/0050131 A1
(43) Pub. Date: Mar. 1, 2007

(54) Navigation device

(75) Inventor: Takahiro Masuda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/326,398

(22) Filed: Jan. 6, 2006

(30) Foreign Application Priority Data
Aug. 31, 2005 (JP) JP2005-252696

(51) Int. Cl. G01C 21/00

(52) U.S. Cl. 701/209; 701/200; 340/995.23

(57) ABSTRACT

To provide a technology enabling proper navigation based on positional information of a visitor and a congested state. Readers provided in a plurality of locations within an object area read a piece of identifying information from a tag of a visitor, receive the identifying information from the reading device, an input of a destination of the visitor is received, by referring to a map information storage module stored with map information within the object area including the installing locations of the reading units, a present position of the visitor whose identifying information has been read is acquired, then a congested state is obtained from an information count of the identifying information read by each of the reading units, and a route to the destination from the present position of the visitor is acquired in a way that weights (a value of) the congested state to the map information.

### BACKGROUND OF THE INVENTION

The invention relates to a route guidance (navigation) technology in an object area such as an exhibition place.

Automobiles etc. widely utilize a navigation system for obtaining a present position on the basis of radio waves received from a GPS (Global Positioning System), i.e., an artificial satellite, and showing an optimal route by referring to map information.

Further, technologies disclosed in, e.g., the following Patent documents 1-11 are given as the prior arts related to the invention of the present application.

[Patent document 1] Japanese Patent Application Publication No.3403282

[Patent document 2] Japanese Patent Application Laid-Open Publication No.2004-133782

[Patent document 3] Japanese Patent Application Laid-Open Publication No.2001-326598

[Patent document 4] Japanese Patent Application Laid-Open Publication No.2000-236571

[Patent document 5] Japanese Patent Application Laid-Open Publication No.2004-88361

[Patent document 6] Japanese Patent Application Laid-Open Publication No.2000-330971

[Patent document 7] Japanese Patent Application Laid-Open Publication No.2003-135813

[Patent document 8] Japanese Patent Application Laid-Open Publication No.2003-47783

[Patent document 9] Japanese Patent Application Laid-Open Publication No.2004-88361

[Patent document 10] Japanese Patent Application Laid-Open Publication No.2000-330971

[Patent document 11] Japanese Patent Application Laid-Open Publication No.2003-135813

### SUMMARY OF THE INVENTION

The GPS is capable of specifying the position on the unit of only more than ten meters but is incapable of conducting fine navigation such as indicating a course to a certain booth in an event hall etc. Further, a problem is that the GPS can not be utilized in an indoor location etc. that is unable to receive radio waves from the GPS satellite.

Moreover, what is received from the GPS satellite is only information about positioning, and a different method must be used for knowing a congested state on the route leading to a destination.

Such being the case, the invention enables proper navigation based on positional information of a visitor and a congested state.

The invention adopts the following configurations in order to solve the problems.

Namely, a navigation device according to the invention comprises an identifying information receiving unit receiving a piece of identifying information read from a tag of a visitor by a reading unit provided in each of a plurality of locations within an object area, a map information storage module stored with map information within the object area including the installing locations of the reading units, a destination receiving unit receiving an input of a destination of the visitor, and a route determining unit obtaining, by referring to the map information, a present position of the visitor whose identifying information has been read, then obtaining a congested state from an information count of the identifying information read by each of the reading units, and acquiring a route to the destination from the present position of the visitor in a way that weights (a value of) the congested state to the map information.

Further, a navigation system, according to the invention, including reading devices provided in a plurality of locations within an object area and each receiving a piece of identifying information read from a tag of a visitor, and a navigation device, the navigation device comprising, an identifying information receiving unit, a map information storage module stored with map information within the object area including the installing locations of the reading units, a destination receiving unit receiving an input of a destination of the visitor, and a route determining unit obtaining, by referring to the map information, a present position of the visitor whose identifying information has been read, then obtaining a congested state from an information count of the identifying information read by each of the reading units, and acquiring a route to the destination from the present position of the visitor in a way that weights (a value of) the congested state to the map information.

The map information may contain information of a plurality of nodes set at predetermined points including the reading unit installing locations within the object area, information of edges each connecting the node to the node and information of a cost taken for traveling along the edge, and the route determining unit may determine, based on the map information, a node-to-edge combination exhibiting a minimum cost as an optimal route in the combinations of the nodes from a node corresponding to the present position and a node corresponding to a destination and edges.

The route determining unit may put a weight on the traveling time as the cost in accordance with the congested state.

The navigation device may further comprise an event information storage module stored with start time of an event in the destination, wherein the route determining unit may determine, based on the traveling time as the cost and on the present time, a route reaching the destination by the start time of the event.

The navigation device may further comprise a readout information storage module stored with time when the reading unit reads the identifying information, wherein the route determining unit may obtain a distance between the nodes corresponding to the reading units that have read the identifying information on the basis of the map information, then obtains a traveling speed of the visitor specified by the identifying information from the node-to-node distance and the time when reading the identifying information, and may obtain the traveling time from the traveling speed of the visitor and from the node-to-node distance.

When the destination receiving unit receives inputs of a plurality of destinations, the route determining unit may obtain a route for visiting round all the destinations from the present position.

Further, a navigation method, according to the invention, by which a computer receives a piece of identifying information read from a tag of a visitor by a reading unit provided in each of a plurality of locations within an object area, receives an input of a destination of the visitor, then obtains, by referring to a map information storage module stored with map information within the object area including the installing locations of the reading units, a present position of the visitor whose identifying information has been read, further obtains a congested state from an information count of the identifying information read by each of the reading units, and acquires a route to the destination from the present position of the visitor in a way that weights (a value of) the congested state to the map information.

Further, a navigation method according to the invention, making reading devices provided in a plurality of locations within an object area read a piece of identifying information from a tag of a visitor, making a navigation device receive the identifying information from the reading device, receive an input of a destination of the visitor, obtain, by referring to a map information storage module stored with map information within the object area including the installing locations of the reading units, a present position of the visitor whose identifying information has been read, then obtain a congested state from an information count of the identifying information read by each of the reading units, and acquire a route to the destination from the present position of the visitor in a way that weights (a value of) the congested state to the map information.

When the map information contains information of a plurality of nodes set at predetermined points within the object area, information of edges each connecting the node to the node and information of a cost taken for traveling along the edge, the route determining step may involve determining, based on the map information, a node-to-edge combination exhibiting a minimum cost as an optimal route in the combinations of the nodes from a node corresponding to the present position and a node corresponding to a destination and edges.

On the occasion of determining the route, a weight may be put on the traveling time as the cost in accordance with the congested state.

On the occasion of determining the route, start time may be read from an event information storage module stored with the start time of an event in the destination, and a route reaching the destination by the start time of the event may be determined based on the traveling time as the cost and on the present time.

In a case where a read out information storage module is stored with time when the reading unit reads the identifying information, on the occasion of determining the route, a distance between the nodes corresponding to the reading units that have read the identifying information may be obtained based on the map information, then a traveling speed of the visitor specified by the identifying information may be obtained from the node-to-node distance and the time when reading the identifying information, and the traveling time may be obtained from the traveling speed of the visitor and from the node-to-node distance.

In the case of receiving inputs of a plurality of destinations, on the occasion of determining the route, a route for visiting round all the destinations from the present position may be obtained.

Further, the invention may also be a navigation program making a computer execute the navigation method. Still further, the invention may also be a readable-by-computer recording medium recorded with this navigation program. The computer is made to read and execute the program on this recording medium, whereby the functions thereof can be provided.

Herein, the readable-by-computer connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the recording mediums fixed within the computer.

According to the invention, it is possible to provide the technology enabling the proper navigation based on the positional information of the visitor and the congested state.

### BRIEF DESCRIPTION OF THE DRAWINGS

FIG.1 is an explanatory diagram of a navigation system of the invention.

FIG. 2 is a schematic view of a theme park in which the navigation system is installed.

FIG. 3 is a diagram of function blocks of a navigation device.

FIG. 4 is an explanatory diagram of an event information storage module.

FIG. 5 is an explanatory diagram of a usage schedule storage module.

FIG. 6 is an explanatory diagram of a node map of a map information storage module.

FIG. 7 is an explanatory diagram of an edge map of the map information storage module.

FIG. 8 is an explanatory diagram of a readout history storage module.

FIG. 9 is an explanatory diagram of a navigation method.

### DETAILED DESCRIPTION OF THE PREFERRED EMBODIMENT

<Whole Architecture>

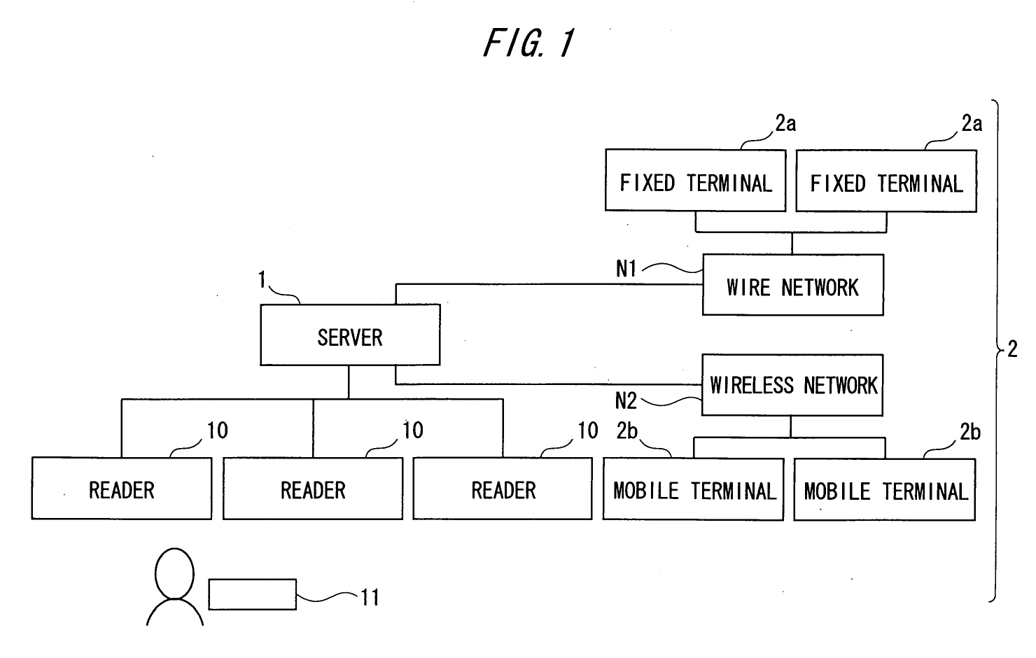

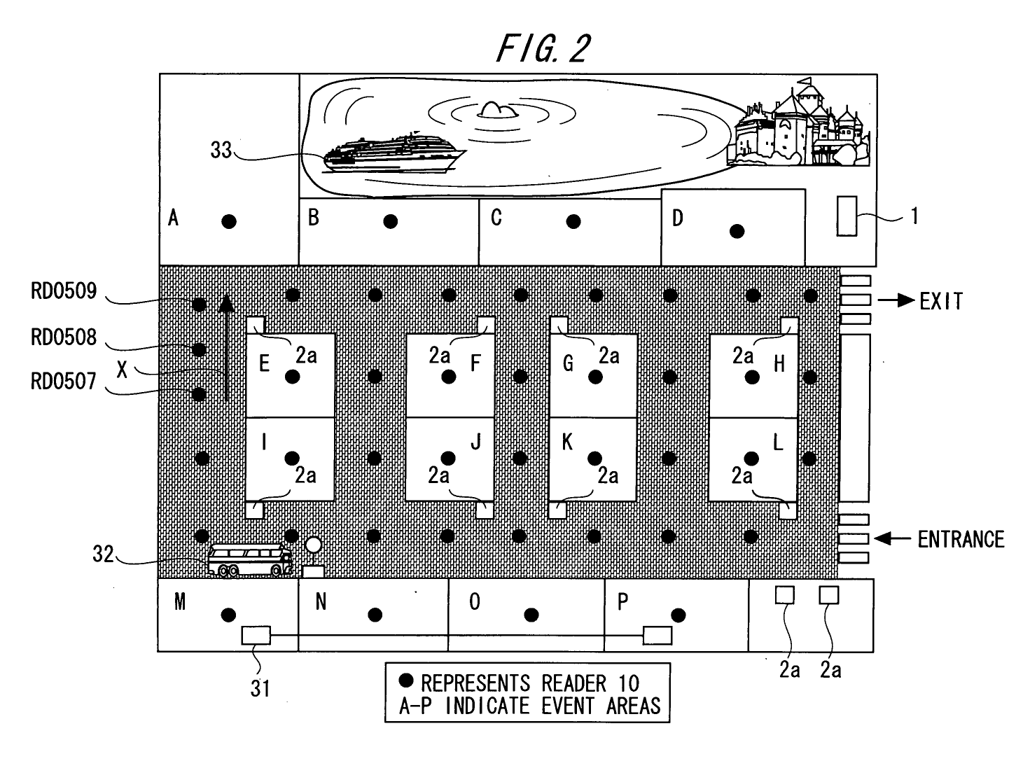

FIG. 1 is an explanatory diagram of a route guidance system (navigation system) including a route guidance device (navigation device) according to the invention. FIG. 2 is a schematic diagram in a case where the navigation system is installed in a theme park serving as an object area. In FIG. 2, black circles designate readers (reading units) 10, rectangles marked with A-P represent event areas. The navigation system includes the plurality of reading devices (readers) 10 installed in the object area, the navigation device, and a network that connects these devices to each other. A server 1 as the navigation device receives identifying information that is read from an admission ticket (RFID: Radio Frequency Identification) of each visitor by the reader 10, thereby recognizing a position of each individual visitor and the number of visitors. Further, the server 1 receives, from a visitor's terminal 2, an input of a planned event (visitor's destination) to be used, acquires an optimal route to the destination from a position where each visitor now exists, and transmits the acquired route to the visitor's terminal 2. Herein, the server 1 in the embodiment is capable of guiding the visitor to a proper router as by avoiding a congested area in a way that takes account of a congested state on the route.

<Explanation of Each Component>

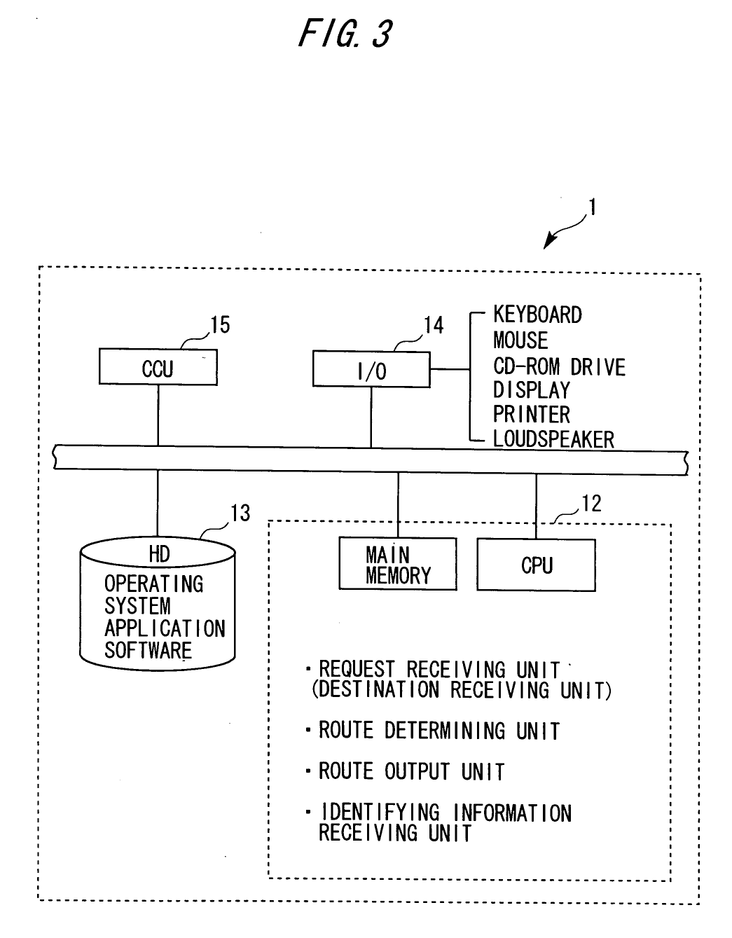

FIG. 3 is a schematic diagram of a configuration of the server 1. As shown in FIG. 3, the server 1 is a multi-purpose computer including an arithmetic processing unit 12, a storage unit (hard disk) 13, an input/output unit 14, a communication control unit 15 and so on.

Input devices such as the reader 10, a keyboard, a mouse and a CD-ROM drive, and output devices such as a display device and a printer are properly connected to the I/O port 14.

The communication control unit 15 controls communications with other computers via a network.

The storage unit 13 is preinstalled with an operating system (OS) and application software (a navigation program etc.). Further, the storage unit 13 including a map information storage module (unit) stored with map information (node map/edge map) within the object area including installing locations of the readers 10, an event information storage module, a usage schedule storage module and a read history storage module.

The arithmetic processing unit 12, which is constructed of a CPU (Central Processing Unit), a main memory, etc., properly reads the OS and the application software from the storage unit 13 and executes the OS and the application software, then performs arithmetic processes of pieces of information inputted from the I/O port 14 and from the communication control unit 15 and also information read from the storage unit 13, thereby functioning also as an identifying information receiving module, a request receiving module (including a destination receiving module), a route determining module and a route outputting module.

This identifying information receiving module receives the identifying information read from a tag (IC chip) of the visitor by each of the readers 10 provided in the plurality of locations within the object area.

The request receiving module receives requests for inputting the destination of the visitor, calculating the route, acquiring the event information, etc.

The route determining module obtains the position where the visitor now exists on the basis of the installing location of the reader that has read the identifying information of the visitor, then obtains a congested state from an identifying information count of the identifying information read by each reader, and thus obtains a route from the present position of the visitor to the destination in a way that weights (a value of) the congested state to the map information.

The route outputting module outputs the route to a fixed terminal 2a fixedly provided within the theme park and to a mobile terminal 2b of the visitor.

On the other hand, the fixed terminal 2a is a multi-purpose computer including an arithmetic processing unit constructed of a CPU, a memory, etc., a storage unit such as a hard disc, an input unit such as the reader 10 and an operation unit (keyboard), an output unit such as a display device and a printer, a communication control unit for performing the communications with other computers such as the server 1, and so forth.

The fixed terminal 2a is connected to the server 1 via a wire network N1, wherein the communication control unit transmits requests inputted by a visitor's operation from the input unit to the server 1. Then, the fixed terminal 2a, when receiving the route information and the event information as answers to the requests from the server 1, outputs these items of information from the display device and the printer, thus providing the information to the visitor who made the requests.

Further, the mobile terminal 2b is a computer (an information processing device) including an arithmetic processing unit constructed of a CPU, a memory, etc., a storage unit such as a nonvolatile memory, an input unit such as the reader 10 and the operation unit (the keyboard), an output unit such as the display device and a loudspeaker, a communication control unit for performing the communications with other computers such as the server 1, and so on, and is a PDA (Personal Digital Assistant), a cellular phone, etc. that include an information processing function.

Further, the mobile terminal 2b is connected to the server 1 via a wireless network N2, wherein the communication control unit transmits requests inputted by a visitor's operation from the input unit to the server 1. Then, the mobile terminal 2b, when receiving the route information and the event information as answers to the requests from the server 1, outputs these items of information from the display device and the printer, thus providing the information to the visitor who made the requests.

<Identification Tag 11 and Reader 10>

In the theme park, the visitor (customer) purchases a ticket (an admission ticket) at the entrance and then enters the park, wherein each individual visitor shall carry the ticket during a stay in the theme park. Further, a category of the visitor may include a theme park staff such as a guide staff and a relief staff if they hold the admission tickets.

An RFID (Radio Frequency Identification) tag as the tag 11 readable by the reader 10 is embedded in this admission ticket. This RFID tag has each a unique piece of identifying information, and, when receiving radio waves from the reader 10, transmits the identifying information as carried on the radio waves in response to the received radio waves.

Moreover, the readers 10 for reading the identifying information from the RFID tag are installed in predetermined locations such as the respective event areas A-P, paths, an exit and the entrance in the theme park. Each reader 10 transmits the readout identifying information directly or via the terminal 2 to the server 1.

A readable distance of the reader 10 from the RFID tag 11 is set to several centimeters (cm) through ten-odd meters (m) corresponding to accuracy needed for specifying a position of the visitor.

It is to be noted that the identification tag 11 may involve using, without being limited to those issued on the side of the theme park, an IC card possessed by the visitor and a cellular phone having an IC card function. In this case, a unique piece of identifying information issued by the server 1 when entering the park is written to the visitor's IC card or the cellular phone, or alternatively the unique identifying information recorded on the IC card or the cellular phone is read out and registered in the server 1.

<Event Information>

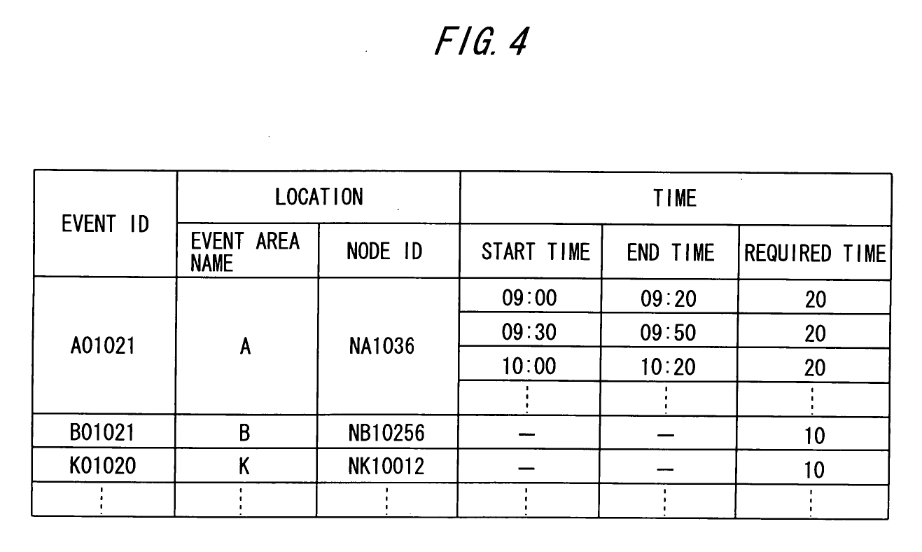

The server 1 previously stores the event information storage module with information on events that take place in the theme park. The event information storage module contains, as shown in FIG. 4, unique information (an event ID) for identifying each event, information on locations (specified by coordinates, the event areas A-P and node IDs) where the events take place, and event time (start time, end time and required time). In the embodiment, categories of the events may be show-watching, getting-on-a-vehicle, eating at a restaurant, shopping, etc. on condition that these things are conducted inside the theme park.

<Event Registration Process>

Each visitor previously registers the scheduled-to-use events in the server 1. The registration of the scheduled-to-use events is done in the following procedures.

Procedure 1) Case of Making Pre-Registration

1-1. The theme park previously provides event information (a schedule of the shows, new attractions, time of a parade, etc.) scheduled to be held as by distributing the information through advertising media or selling guidebooks, and so on.

1-2. Each visitor accesses the server 1 via the network by operating the cellular phone or the personal computer, then previously designates the want-to-use events with reference to the event information, and registers the designated events in the server 1.

1-3. When receiving this event registration, the server 1 records an event usage schedule in a way that assigns an ID to this schedule, and notifies the visitor of this event usage schedule ID. Note that if desiring to modify this usage schedule, the visitor accesses the server 1 and modifies items of data (record) associated with this ID.

1-4. The visitor, when visiting the theme park, receives the issue of the admission ticket (RFID) and inputs the identifying information and the schedule ID to the visitor's terminal 2a or the mobile terminal 2b. The fixed terminal 2a transmits the identifying information and the schedule ID to the server 1. Further, the mobile terminal 2b transmits the identifying information, the schedule ID and an address of the mobile terminal to the server 1.

1-5. With this operation, the server 1 stores the usage schedule specified by the schedule ID and the identifying information in association with each other. Note that when receiving the address of the mobile terminal 2b, this address is also stored in association with the usage schedule and the identifying information.

Procedure 2) Case of Making Registration by Fixed Terminal 2a

2-1. The visitor, when entering the theme park, receives the issue of the admission ticket.

2-2. The visitor gets the identifying information on the admission ticket read by the fixed terminal 2a installed inside the theme park, and inputs the visitor's wanting-to-use events.

2-3. The fixed terminal 2a sends the event usage schedule and the identifying information to the server 1.

2-4. The server 1 stores the received the usage schedule and identifying information in association with each other.

Procedure 3) Case of Making Registration by Mobile Terminal 2b

3-1. The visitor, when entering the theme park, receives the issue of the admission ticket.

3-2. The visitor inputs the identifying information on the admission ticket issued to the mobile terminal 2b.

3-3. The mobile terminal 2b accesses the server 1 and acquires the event information.

3-4. The mobile terminal 2b displays the acquired event information and prompts the visitor to input the scheduled-to-use events.

3-5. When the usage schedule is inputted by the visitor's operation, the mobile terminal 2b transmits the usage schedule, the identifying information and the address of the mobile terminal to the server 1.

3-6. The server 1 stores the usage schedule, the identifying information and the address of the mobile terminal in association with each other, which have thus been received.

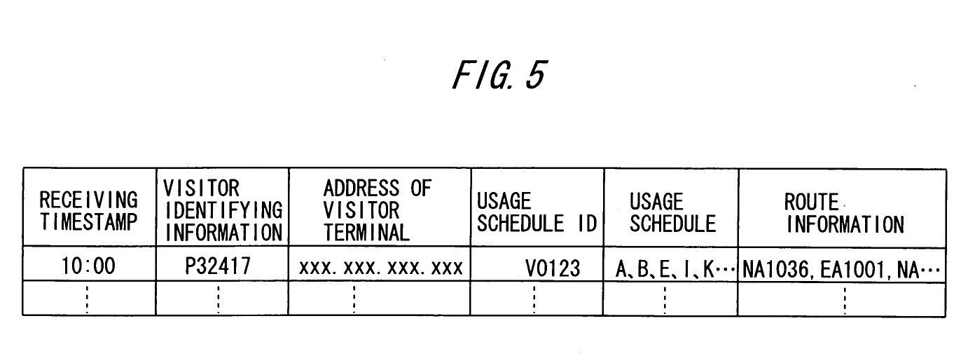

FIG. 5 is an explanatory diagram of the usage schedule storage module on which the server 1 stores the usage schedules. As shown in FIG. 5, the usage schedule storage module is stored with a timestamp at receiving time, a visitor identifying information, an address of visitor's terminal, a usage schedule ID, a usage schedule and route information.

<Storage of Map Information>

The server 1 is recorded with map information within the theme park. In the embodiment, the map information contains node information and edge information.

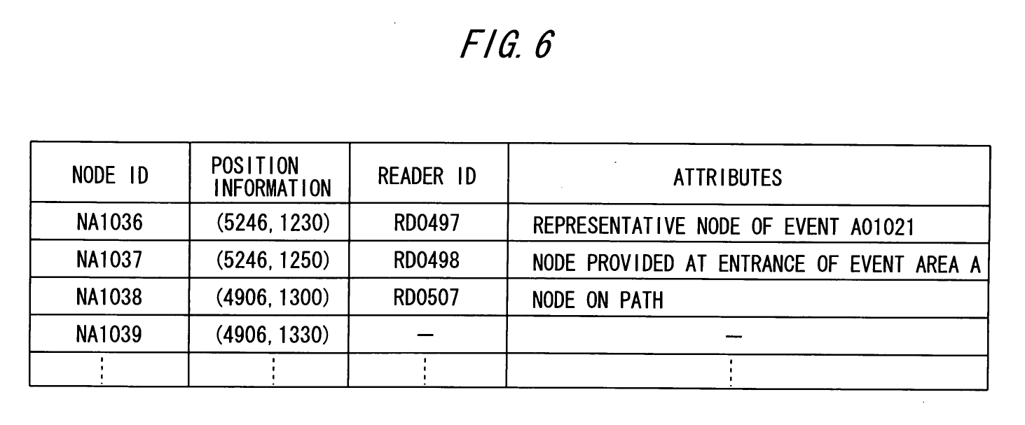

FIG. 6 is an explanatory diagram of a node information storage module stored with the node information. Selected and set as “nodes” according to the necessity from, within the theme park, all the intersecting points of two or more paths, all the terminal points as dead ends, all the points making it possible to determine which means is selected from a plurality of travelling means as in the case of getting-on/off-places for a boat 33, an intra-park bus 32 and a ropeway 31, and other primary points including the installing locations of the readers 10. All the nodes are assigned unique numbers (node IDs). Recorded as the node information are a node ID of each node, a node location (coordinate), identifying information (a reader ID) specifying the reader 10 in the case of a point where the reader 10 is installed, and an attribute of the installing location that indicates which event area the node is installed in or which path the node is installed on.

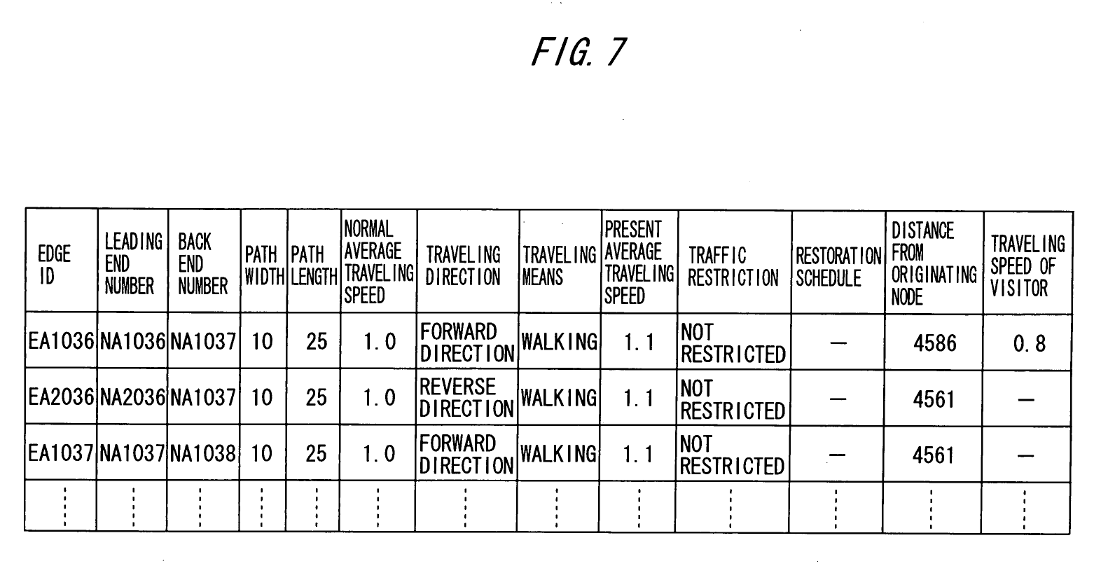

FIG. 7 is an explanatory diagram of an edge information storage module. All the paths within the theme park are described as an aggregation of “edges each connecting two nodes (none of other nodes exist on the edge”. The embodiment gives a distinction in terms of representation between the “edge” focused on a node connecting function in a graphic theory and the “path” focused on a visitor's passage related function as based on an actual width. In the case of preparing the traveling means such as the “bus”, the “boat” and the “ropeway” in addition to “walking”, an edge is described for every traveling means. Further, the edge may also be provided in every traveling direction of the visitor who travels between the two nodes. For example, in the case of one-way traffic between the two nodes, only one edge is provided in this direction, and, in the case of being able to travel toward either node, two edges are provided both in one direction and in the other direction.

The edge information storage module is stored with the following items of information as shown in FIG. 7 by way of the edge information of the edges.

a) Edge ID: identifying information for specifying the edge.

b) Leading end number: the smaller number of the node numbers of the end points (nodes) of the edge.

c) Back end number: the larger number of the node numbers of the end points (nodes) of the edge.

d) Path width: a passable path width (the minimum length measured in a direction orthogonal to the traveling direction).

e) Path length: a length measured in the direction along the path.

f) Traveling speed: an average traveling speed in a non-congested state.

g) Traveling directions: a forward direction in the case of traveling from the node having the smaller node number to the node having the larger node number, and a reverse direction in the case of traveling from the node having the larger node number to the node having the smaller node number.

h) Traveling means: a category of the traveling means (e.g., “walking”, “bus boat”, etc.).

The attributes given above are fixed and, when set once, shall not change.

Further, the following attributes are described in order to reflect momentarily-changing conditions in the guide of the route (navigation) by referring to the information collected from the tag readers.

i) Average traveling speed at the present: an initial value is “the average traveling speed in the non-congested state” and is hereafter updated by the data collected from the tag readers.

j) Traffic restriction: restriction or non-restriction of the traffic is made due to factors such as a sudden accident and an occurrence of a special event (traffic free/one-way traffic/traffic blockage).

k) Restoration schedule time in the case of the traffic restriction.

l) Distance from an originating node

m) Traveling speed of visitor

<Storage of Readout History>

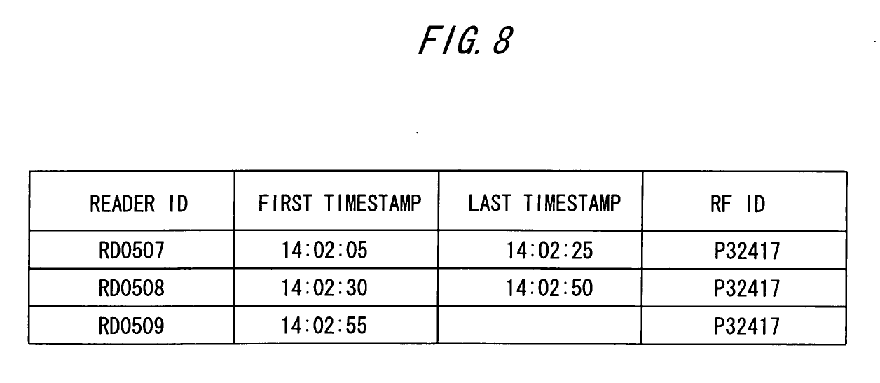

The server 1 stores, when the reader has read the identifying information of each visitor, as shown in FIG. 8, a history of the readout information on the readout history storage module. The recognized identifying information (the visitor's ID), a timestamp (a first timestamp) showing the time when entering a recognizable range, a timestamp (a last timestamp) showing the last time when confirming that the visitor exists in the recognizable range, and an identifier of the reader (a reader identifier) that has recognized the existence, are recorded as a readout history in a way that associates these pieces of information with each other.

The visitor canbe deemedtoexist in the installing location of the reader 10 that has finally read the visitor's ID, and hence the server 1 reads, from the readout history storage module, a reader ID associated with the latest time stamp in the history information (one record) specified by the visitor's ID, and can obtain a position of the visitor by searching through the map information storage module on the basis of the reader ID.

<Judgment as to Whether Visitor is in Middle of Using Event>

Furthermore, the server 1, when the reader 10 reads the identifying information of each individual visitor, judges whether the visitor is in a “which-event-is-now-being-used” stateorina“from-event-area-to-event-area-traveling” state in accordance with the reader information of this reader 10, the map information and the event information. This state judgment is made, for example, as follows.

When having read the identifying information, if the reader installing location is the entrance or the exit of the event area by referring to the reader information of the have-read reader 10, the visitor recognized at the entrance (entering record entered) but not recognized at the exit (exiting record not entered) is deemed to be now using the event. Further, the visitor recognized at the exit after being recognized at the entrance is deemed to be now traveling between the event areas. In the case of the events such as the show and the parade that to be held at the predetermined usage time, the visitor may be deemed to exit because of an elapse of a fixed period of time after the end of the event, i.e., deemed to become the “from-event-area-to-event-area-traveling state”.

In the case of a broad event area, the area is divided into several sub-areas, wherein the tag readers with a setting of a narrower recognizable range are provided, and the visitor recognized by this tag reader is deemed to be now using the event, while the visitor not recognized is deemed not to use any event.

<Calculation of Congested State>

On the occasion of obtaining the route, whether the traveling required time is delayed due to the congestion or not is judged as below.

An administrator of the theme park previously acquires data about “what degree the visitors will gather to on the route and what percentage of the required time for traveling on this route will increase in relation to this gathering degree” with respect to each of the routes, and stores the storage unit 13 with these items of data. On this occasion, the administrator obtains, for example, a correlation between a visitor density, i.e., given by “the number of visitors recognized to exist on the route÷(route width X route length)” and the time needed for traveling on the route. For instance, the correlation is exemplified such as “it takes a 10% extra time to pass through the route if the visitor density on the route exceeds 1.1 persons/m²” and [it takes a 15% extra time to pass through the route if the visitor density on the route exceeds 2.0 persons/m²] (the numerical values given herein are one examples but are not limitative).

The server 1 divides a detected-by-reader visitor count by a reader detectable range (a real size), thus obtaining the visitor density in each reader installing location. Then, the server 1 obtains a traveling speed corresponding to the visitor density by referring to the correlation stored on the storage unit 13, and records this traveling speed as a present average traveling speed in the map information storage module.

<Navigation Method>

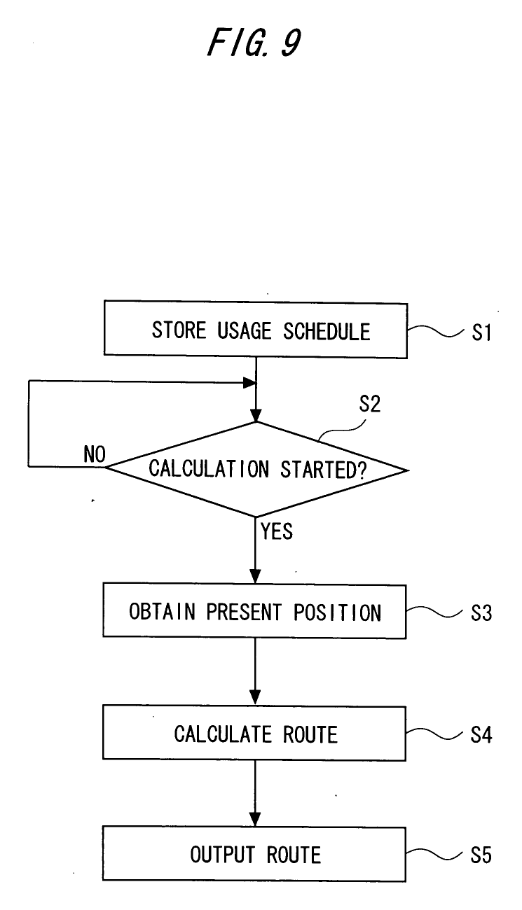

FIG. 9 is an explanatory diagram of a navigation method by which the server 1 acquires the optimal route in the case of using the registered event and provides the optimal route to the visitor.

The server 1, to which the usage scheduled destination (the event) is inputted from the visitor's terminal 2 by the visitor's operation as described above, stores this usage schedule on the usage schedule storage module (step 1, which will hereinafter be abbreviated such as S1).

When receiving a request for the optimal route from the visitor's terminal 2 and when judging that predetermined conditions are met such as a case that the congesting information changes and a case that it is close to the event start time (S2), the server 1 obtains the present position of the visitor by referring to a present position information storage module (S3).

Then, the server 1 calculates the route for visiting round the events on the basis of the present position of the visitor, the usage schedule of the visitor and the map information (S4). For instance, the edge connecting the node corresponding to the location of each event registered as the usage schedule to the node corresponding to the present position, and the nodes (the route) are respectively obtained by Dijkstra method etc. Among those, the event (specified by) connecting the edge(s) exhibiting a minimum cost to the node, i.e., the event to which the visitor can travel at the minimum cost is set as a first event, another event travelable at the minimum cost from the first event is set as a second event, and a travelable-at-the-minimum-cost event in the remaining events is thus sequentially set as a next event. The route for visiting round all the events registered as the usage schedule is thereby determined.

The server 1 records this route on the usage schedule storage module, then transmits the route to the visitor's terminal 2 and gets the route displayed on the display device or printed by the printer, thus presenting the route to the visitor.

<Details of Route Determination>

The embodiment is that on the occasion of determining the route, the required time (the traveling time) at the present time with respect to each edge is obtained from dividing the path length by the traveling speed at the present, and the thus-obtained required time is employed as a cost for each edge. This contrivance is that when the required time for the congested path increases, the cost rises, and therefore it follows that a route avoiding the congestion is selected. Namely, the route weighted depending on a state of how much the path is congested can be selected.

Further, when the event registered as the usage schedule is the show etc., and when the start time is recorded in the event information, the route reaching the event location till the start time is determined in accordance with the traveling time and the present time.

An assumption is, for instance, such that the events in the event areas A, B, E, I and K are registered as the usage schedule, the optimal route (the shortest route) determined in accordance with the traveling time is a route along which to travel to the event areas K, I, E, A and B in this sequence, and the following periods of time are recorded in the map information. Note that the route establishing an area-to-area connection is built up by the plurality of nodes and edges, and, though the time is recorded for every node and every edge, the explanation is herein made on an area-by-area basis in a way that adds up those periods of time for simplicity.

Traveling time from the present position to the event area K=5 min.

Using time of the event in the event area K=10 min.

Traveling time from the event area K to the event area I=10 min.

Using time of the event in the event area I=8 min.

Traveling time from the event area I to the event area E=5 min.

Using time of the event in the event area E=10 min.

Traveling time from the event area E to the event area A=4 min.

Using time of the event in the event area A=20 min.

Traveling time from the event area A to the event area B=3 min.

Using time of the event in the event area B=10 min.

A requisite to this case is that it takes 52 min till the visitor reaches the area A from the present position. Hereat, if the start time of the event in the event area A is 10:00 and the present time is 9:00, it is possible to arrive at the event area A by 10:00 on the shortest route.

If the present time is 9:10, however, it is impossible to reach the event area A by 10:00 along the shortest route. Such being the case, when determining the area E one before the area A, i.e., when selecting the area next to the area I, the area A is preferentially selected. Then, from the area A onward, as described above, the areas are determined such as selecting the area B and the area E corresponding to the cost. Through this operation, it is feasible to reach the event area by the start time. Note that if it does not catch the start time even by advancing the area A by one in the order, the areas may be advanced till it would get anterior to the start time. Further, when the present time is 8:40, the visitor is scheduled to arrive at the event area A at 9:32, and, if a period (28 min) from this arrival schedule time to the start time is shorter than a period (16 min) till the visitor visits the event in the next area B and returns, the priority may be given to the event in the next area.

With this contrivance, the optimal route can be provided corresponding to the start time of the schedule-determined event.

Moreover, this route calculation, if the predetermined conditions are satisfied without being limited to the request from the visitor, may be judged to be done once again (S2).

For example, the server 1 monitors the congested state and, if the congested state exceeds a predetermined value, calculates again the route. In the example, the congested state described above is periodically calculated, and, if the average traveling speed at the present is changed, the route including the edge with this change made in the routes recorded on the usage schedule storage module is recalculated.

Further, the server 1 monitors the start time in the event information, and, when reaching the predetermined time before the start time, may recalculate the route to the (area of) event contained in the usage schedule. For example, the visitor using the event in the event area A is in the event area I at 9:45 behind the schedule, the server 1 makes the recalculation and notifies of a route change so that the visitor moves straightway to the event in the area A next to the area I.

If the route change occurs due to this recalculation, the server 1 updates the routes on the usage schedule storage module, and notifies the visitor of the route change.

When the visitor with this route change occurred employs the mobile terminal 2b, i.e., the address of this terminal 2b is recorded on the usage schedule storage module, the server 1 sends the post-change route information to the address of the mobile terminal 2b.

Moreover, when the visitor employs the fixed terminal, i.e., when the address is not recorded on the usage schedule storage module, the server 1 lists up the identification numbers of the visitors to whom the notification is given, and, if the visitor accesses from the fixed terminal for a different purpose (such as acquiring the whole map of the event places), notifies the visitor of “a purport that the route information is modified” if coincident with the identification number. For others, the reader is provided with the display device, a voice output device, etc., and, when detecting the identifying information of the visitor requiring the change, the purport of the route change may be outputted in voice and may also be displayed.

The visitor, who has received the notification of the route change, accesses the server 1 from the mobile terminal 2b or the fixed terminal 2a, and dares to select the as-is route or updates the route as by selecting a different route recommended by the system or selecting a route steering clear of the event in the vicinity of the congested place.

<Traveling Speed per Visitor>

In the example given above, on the occasion of determining the route, the standard traveling speed is employed, however, the route may also be determined by use of an actual traveling speed of each individual visitor on the basis of a visitor's traveling history.

On the occasion of obtaining the traveling speed of the visitor, the server 1 at first extracts the readout history on the basis of the visitor ID of the visitor from the history information storage module. The readout history in FIG. 8 shows a data example, wherein the visitor, whose visitor ID is P32417, travels along the path as indicated by an arrow line X in FIG. 2 and is recognized by the readers RD0507→RD0508→RD0509. These readers RD0507, RD0508 and RD0509 are disposed along the path as shown in FIG. 2, and position information thereof is recorded on the map information storage module.

Subsequently, the server 1 obtains a path length between the readers (between the nodes) from the map information storage module in association with the reader IDs in the readout history. In the example, the path length between the nodes is 25 meters.

The server 1 obtains a period of time expended for traveling from the reader RD0507 to the reader RD0508 on the basis of the timestamps. For example, the moment of passing through the position of the reader RD0507 is obtained as in the formula 1 from the first timestamp “14:02:05” and the last timestamp “14:02:25” in the reader RD0507, and similarly the moment of passing through the position of the reader RD0508 is obtained as in the formula 2.

The moment of passing through RD0507:
(14:02:25+14:02:05)/2→14:02:15 Formula 1

The moment of passing through RD0508:
(14:02:30+14:02:50)/2→14:02:40 Formula 2

Accordingly, the time expended for traveling from the position of the reader RD0507 to the position of the reader RD0508 is 25 sec.

The server 1 obtains the traveling speed from the time expended for traveling and from the distance between the readers. Specifically, it takes 25 sec to travel 25 meters, and hence [1.00 m/sec] is obtained as the traveling speed of the visitor (P32417). Further, the server 1 sets this traveling speed as a traveling speed in a non-congested case on the basis of the congested state. Namely, the congested state between the readers RD0507 and RD0508 is obtained, wherein the traveling speed is used as it is if not congested, and the traveling speed in the non-congested case is, if congested, acquired by referring to the correlation with the congested state.

The server 1 records this traveling speed as i) the traveling speed of the visitor in the map information storage module. Note that after an end of calculating the traveling speed, the data (if given as the time stamps, the data of 14:02:05 through 14:02:25) about the reader RD0507 may be deleted. As to the thus-obtained traveling speed data, for example, three records of the latest data are saved for each visitor and are deleted in the sequence from the oldest.

Then, the server 1, when obtaining the route (S4), acquires the visitor's traveling speed corresponding to the congested state on each edge by referring not to the average traveling speed on each edge but to the traveling speed of the visitor, and acquires the traveling time (cost) on each edge by use of the visitor's traveling speed corresponding to the congested state, thereby calculating the route in the same way as the above-mentioned.

The route can be thereby calculated corresponding to the traveling speed per visitor, and the visitor can be guided along a further proper route.

As discussed above, according to the embodiment, it is possible to attain the indoor and narrow area navigation, i.e., the navigation that can be said to be a blind-spot area navigation based on the conventional GPS.

<Others>

The invention The invention is not limited to only the illustrated examples given above and can be, as a matter of course, changed in a variety of forms in the range that does not deviate from the gist of the invention.

### INCORPORATION BY REFERENCE

The disclosures of Japanese patent application No.JP2005-252696 filed on Aug. 31, 2005 including the specification, drawings and abstract are incorporated herein by reference.

What is claimed is:

1. A navigation device comprising:
an identifying information receiving unit receiving a piece of identifying information read from a tag of a visitor by a reading unit provided in each of a plurality of locations within an object area;
a map information storage unit stored with map information within the object area including the installing locations of the reading units;
a destination receiving unit receiving an input of a destination of the visitor; and
a route determining unit obtaining, by referring to the map information, a present position of the visitor whose identifying information has been read, then obtaining a congested state from an information count of the identifying information read by each of the reading units, and acquiring a route to the destination from the present position of the visitor in a way that weights the congested state to the map information.

2. A navigation device according to claim 1, wherein the map information contains information of a plurality of nodes set at predetermined points including the reading unit installing locations within the object area, information of edges each connecting the node to the node and information of a cost taken for traveling along the edge, and the route determining unit determines, based on the map information, a node-to-edge combination exhibiting a minimum cost as an optimal route in the combinations of the nodes from a node corresponding to the present position and a node corresponding to a destination and edges.

3. A navigation device according to claim 2, wherein the route determining unit puts a weight on the traveling time as the cost in accordance with the congested state.

4. A navigation device according to claim 2, further comprising an event information storage module stored with start time of an event in the destination,
wherein the route determining unit determines, based on the traveling time as the cost and on the present time, a route reaching the destination by the start time of the event.

5. A navigation device according to claim 4, further comprising a readout information storage module stored with time when the reading unit reads the identifying information,
wherein the route determining unit obtains a distance between the nodes corresponding to the reading units that have read the identifying information on the basis of the map information, then obtains a traveling speed of the visitor specified by the identifying information from the node-to-node distance and the time when reading the identifying information, and obtains the traveling time from the traveling speed of the visitor and from the node-to-node distance.

6. A navigation device according to claim 1, wherein when the destination receiving unit receives inputs of a plurality of destinations, the route determining unit obtains a route for visiting round all the destinations from the present position.

7. A navigation method by which a computer executes steps of:
receiving a piece of identifying information read from a tag of a visitor by a reading unit provided in each of a plurality of locations within an object area;
receiving an input of a destination of the visitor; and
obtaining, by referring to a map information storage module stored with map information within the object area including the installing locations of the reading units, a present position of the visitor whose identifying information has been read, then obtaining a congested state from an information count of the identifying information read by each of the reading units, and acquiring a route to the destination from the present position of the visitor in a way that weights the congested state to the map information.

8. A navigation method according to claim 7, wherein the map information contains information of a plurality of nodes set at predetermined points including the reading unit installing locations within the object area, information of edges each connecting the node to the node and information of a cost taken for traveling along the edge, and
the route determining step involves determining, based on the map information, a node-to-edge combination exhibiting a minimum cost as an optimal route in the combinations of the nodes from a node corresponding to the present position and a node corresponding to a destination and edges.

9. A navigation method according to claim 8, wherein the route determining step involves putting a weight on the traveling time as the cost in accordance with the congested state.

10. A navigation method according to claim 8, wherein the route determining step involves reading start time from an event information storage module stored with the start time of an event in the destination, and determining, based on the traveling time as the cost and on the present time, a route reaching the destination by the start time of the event.

11. A navigation method according to claim 10, wherein there is executed a step of storing a readout information storage module with time when the reading unit reads the identifying information, and
the route determining step involves obtaining a distance between the nodes corresponding to the reading units that have read the identifying information on the basis of the map information, then obtaining a traveling speed of the visitor specified by the identifying information from the node-to-node distance and the time when reading the identifying information, and obtaining the traveling time from the traveling speed of the visitor and from the node-to-node distance.

12. A navigation method according to claim 7, wherein when the destination receiving step involves receiving inputs of a plurality of destinations, the route determining steps involves obtaining a route for visiting round all the destinations from the present position.

13. A recording medium stored with a navigation program making a computer executes steps of:
receiving a piece of identifying information read from a tag of a visitor by a reading unit provided in each of a plurality of locations within an object area;
receiving an input of a destination of the visitor; and
obtaining, by referring to a map information storage module stored with map information within the object area including the installing locations of the reading units, a present position of the visitor whose identifying information has been read, then obtaining a congested state from an information count of the identifying information read by each of the reading units, and acquiring a route to the destination from the present position of the visitor in a way that weights the congested state to the map information.

14. A recording medium according to claim 13, wherein the map information contains information of a plurality of nodes set at predetermined points including the reading unit installing locations within the object area, information of edges each connecting the node to the node and information of a cost taken for traveling along the edge, and
the route determining step involves determining, based on the map information, a node-to-edge combination exhibiting a minimum cost as an optimal route in the combinations of the nodes from a node corresponding to the present position and a node corresponding to a destination and edges.

15. A recording medium according to claim 14, wherein the route determining step involves putting a weight on the traveling time as the cost in accordance with the congested state.

16. A recording medium according to claim 14, wherein the route determining step involves reading start time from an event information storage module stored with the start time of an event in the destination, and determining, based on the traveling time as the cost and on the present time, a route reaching the destination by the start time of the event.

17. A recording medium according to claim 16, wherein there is executed a step of storing a readout information storage module with time when the reading unit reads the identifying information, and
the route determining step involves obtaining a distance between the nodes corresponding to the reading units that have read the identifying information on the basis of the map information, then obtaining a traveling speed of the visitor specified by the identifying information from the node-to-node distance and the time when reading the identifying information, and obtaining the traveling time from the traveling speed of the visitor and from the node-to-node distance.

18. A recording medium according to claim 13, wherein when the destination receiving step involves receiving inputs of a plurality of destinations, the route determining steps involves obtaining a route for visiting round all the destinations from the present position.
